(19) United States
(12) Patent Application Publication
(10) Pub. No.: US 2026/0288766 A1
(43) Pub. Date: Sep. 24, 2026

(54) SYSTEMS AND METHOD FOR TRACKING ELECTRONIC COMMUNICATIONS AND PARTICIPANT RELATIONSHIPS

(71) Applicants: Justin Banford, Fairfax Station, VA (US); Andras Rakicsany, Vienna, VA (US)

(72) Inventors: Justin Banford, Fairfax Station, VA (US); Andras Rakicsany, Vienna, VA (US)

(21) Appl. No.: 19/083,315

(22) Filed: Mar. 18, 2025

(51) Int. Cl. G06F 16/28; G06F 40/205

(52) U.S. Cl. CPC G06F 16/288; G06F 40/205

(57) ABSTRACT

A method for tracking electronic communications includes receiving an electronic message between a first user and a second user. The method includes parsing the electronic message to extract data and metadata. The method includes providing the data and the metadata to a plurality of artificial intelligence (AI) agents. Each AI agent employs a natural language processing model trained to analyze electronic messages. The method includes enabling the plurality of AI agents to collaboratively determine, through a consensus mechanism, relational connections among the first user, the second user, and additional users based on predefined directives. The method includes storing the relational connections identified by the AI agents in a structured database. The method includes generating a relational report including at least one relational connection identified between the second user and a third user. The method includes transmitting the relational report.

### CROSS-REFERENCE TO RELATED APPLICATIONS

This application claims the benefit of priority of U.S. provisional application No. 63/566,515, filed Mar. 18, 2024, titled “SYSTEMS AND METHOD FOR TRACKING ELECTRONIC COMMUNICATIONS AND PARTICIPANT RELATIONSHIPS”, the entire contents of which are herein incorporated by reference.

### FIELD

The present disclosure relates to electronic communications and, more particularly, to systems and methods for tracking electronic communications.

### SUMMARY

One aspect of the present disclosure is directed to a method for tracking electronic communications. The method includes receiving an electronic message between a first user and a second user. The method also includes parsing the electronic message to extract data and metadata. Further, the method includes providing the data and the metadata to a plurality of artificial intelligence (AI) agents. Each AI agent employs a natural language processing model trained to analyze electronic messages. The method includes enabling the plurality of AI agents to collaboratively determine, through a consensus mechanism, relational connections among the first user, the second user, and additional users based on predefined directives. Additionally, the method includes storing the relational connections identified by the AI agents in a structured database. The method also includes generating a relational report including at least one relational connection identified between the second user and a third user. The method includes transmitting the relational report to at least one of the first user or the second user.

Another aspect of the present disclosure is directed to a computer-readable medium storing instructions for causing a processor to perform a method for tracking electronic communications. The method includes receiving an electronic message between a first user and a second user. The method also includes parsing the electronic message to extract data and metadata. Further, the method includes providing the data and the metadata to a plurality of artificial intelligence (AI) agents. Each AI agent employs a natural language processing model trained to analyze electronic messages. The method includes enabling the plurality of AI agents to collaboratively determine, through a consensus mechanism, relational connections among the first user, the second user, and additional users based on predefined directives. Additionally, the method includes storing the relational connections identified by the AI agents in a structured database. The method also includes generating a relational report including at least one relational connection identified between the second user and a third user. The method includes transmitting the relational report to at least one of the first user or the second user.

Another aspect of the present disclosure is directed to a method for tracking electronic communications. The method includes receiving an electronic mail message between a first user and a second user. The method includes parsing the electronic message to extract data and metadata. The method also includes providing the data and the metadata to a plurality of artificial intelligence (AI) agents. Each AI agent employs a natural language processing model trained to analyze electronic messages. The message includes determining, via the AI agents, relational connections among the first user, the second user, and additional users. The method includes storing the relational connections identified by the AI agents in a structured database. Further, the method includes providing the relational connections to a relationship management application.

### BRIEF DESCRIPTION OF THE DRAWINGS

FIG. 1 is a diagram of a network communication system, according to aspects of the present disclosure;

FIG. 2 is a diagram of a communication monitoring system, according to aspects of the present disclosure;

FIGS. 3A-3C is a diagram of a communication monitoring application and process, according to aspects of the present disclosure; and

FIGS. 4A-4E are screenshots of interfaces for the communication monitoring application, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Lead generation refers to the process of identifying and attracting potential customers (leads) for a business. Many programs and tools are designed to help with lead generation, whether for sales, marketing, or business development purposes. These programs and tools require a user to extract and identify the relevant data to be input into tools.

Implementation of the present disclosure describes a communication monitoring system, method, and computer-readable media that maps business-to-business relationships based on evidence-based observed relationships as opposed to the traditional self-report data found in CRM and PRM systems. The communication monitoring system can extract evidence from electronic messages exchanged between participants. The evidence can be tangible as business transitions eventually occur in a high number of cases based on observed referrals, creating a significant economic gain for receivers of a referral. Mapping can be done with the implied consent of the participants for the expressed need to quantify the value of a particular business relationship to be able to choose the most economically attractive business partner for a given transaction, even when multiple similarly qualified parties exist by selecting the one which results in the highest probability of reciprocity.

In implementations, the communication monitoring system operates using artificial intelligence, e.g., one or more machine learning algorithms and models. The communication monitoring system operates without a traditional interface, minimizing friction in the transaction by intelligently parsing natural language human conversations, extracting the referral type, who is referred and to whom with high precision and accuracy. Mapping business-to-business transactions forged in email with the use of a specially designed AI interpreter and advanced conditional prompt engineering. The communication monitoring system can map naturally occurring business relationships as a byproduct of producing quantitative statistical reporting of transactions taking place between parties.

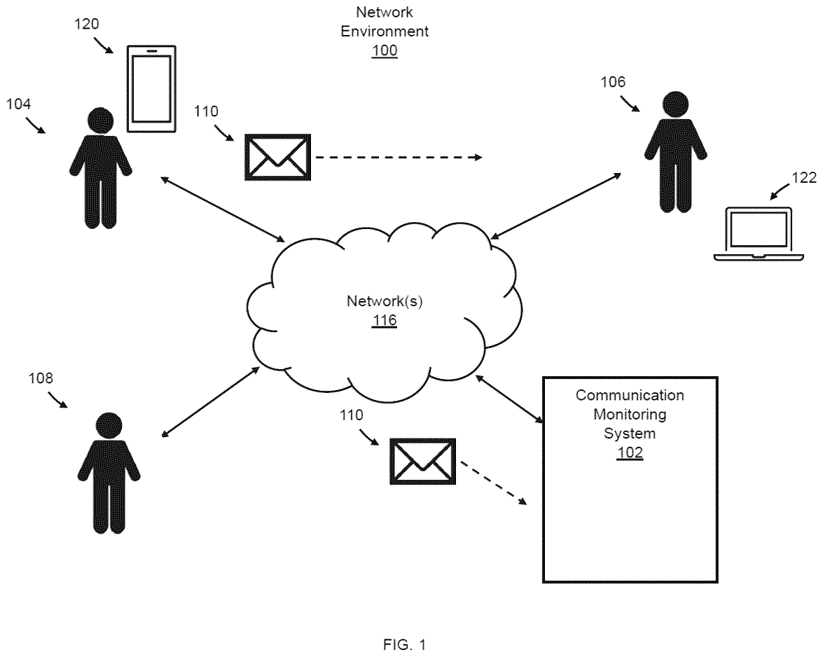

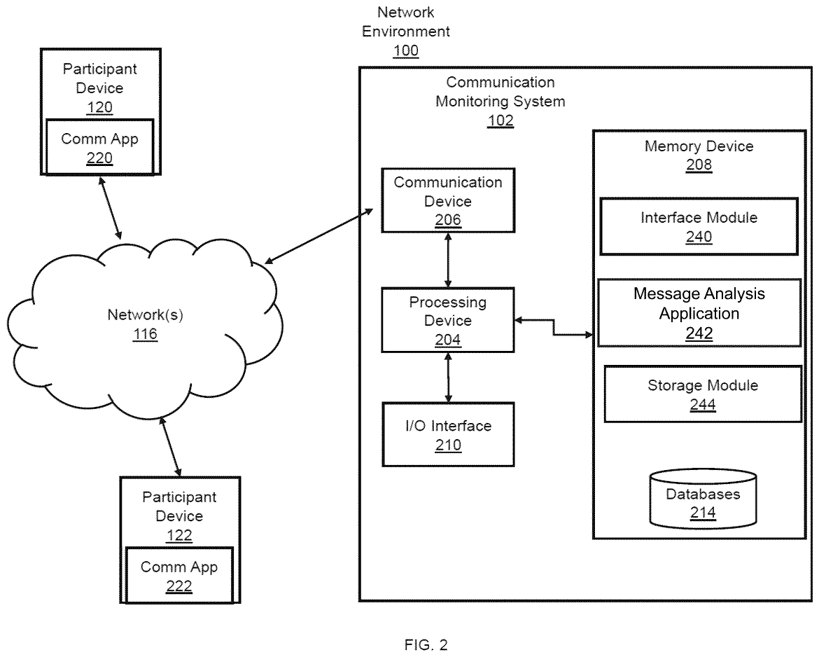

Referring now to FIGS. 1 and 2, FIG. 1 illustrates a network environment 100 including a communication monitoring system 102, according to aspects of the present disclosure. FIG. 2 illustrates the communication monitoring system 102, according to aspects of the present disclosure. While FIGS. 1 and 2 illustrate examples of components of the network environment 100 and the communication monitoring system 102, additional components can be added and existing components can be removed and/or modified.

As illustrated in FIG. 1, the network environment 100 can include one or more participants, e.g., a participant 104, a participant 106, and a participant 108. The participants can communicate with one another using various forms of electronic communication over one or more networks 116. For example, the participant 104 can transmit electronic messages, e.g., emails, text messages, instant messages, etc., to the participant 106. The participants can exchange electronic messages using one or more user devices, e.g., a user device 120 and a user device 122. The user device 120 and/or the user device 122 can include one or more electronic devices such as a laptop computer, a desktop computer, a tablet computer, a smartphone, a thin client, and the like.

In embodiments, the communication monitoring system 102 can be configured to receive an electronic message 110 and extract data from the message 110. The communication monitoring system 102 can be configured to map business-to-business relationships based on evidence-based observed relationships as opposed to the traditional self-report data found in CRM and PRM systems. The evidence can be tangible as business transitions eventually occur in a high number of cases based on observed referrals, creating a significant economic gain for receivers of a referral. Mapping can be done with the implied consent of the participants for the expressed need to quantify the value of a particular business relationship to be able to choose the most economically attractive business partner for a given transaction, even when multiple similarly qualified parties exist by selecting the one which results in the highest probability of reciprocity. The communication monitoring system 102 is configured to operate artificial intelligence (AI), e.g., one or more machine learning algorithms and models. The communication monitoring system 102 operates to capture relevant data without requiring active input by the participants, minimizing friction in the transaction by intelligently parsing data in the message 110, e.g., parsing natural language human conversations, extracting the referral type, who is referred and to whom with high precision and accuracy. The communication monitoring system 102 can be configured to monitor and map business-to-business transactions that occur in the electronic message 110. The communication monitoring system 102 utilizes a specially designed and trained AI interpreter and advanced conditional prompt engineering. The communication monitoring system 102 can map naturally occurring business relationships as a byproduct of producing quantitative statistical reporting of transactions taking place between parties.

The communication monitoring system 102 can be useful in various settings and participants exchanging electronic messages. For example, the communication monitoring system 102 can be configured to monitor all sizes of businesses and entities to better understand how their workforce interacts with other businesses (often in different lines of business) in a way that is observed (so that insights are high quality and accurate) and can provide enterprises with evidence-based acquisition intelligence (who to buy), reliability (observed from the reciprocity levels of parties) amongst many other factors. The communication monitoring system 102 can operate on both internal and external electronic messages. For example, employee's transactions with other businesses depict the interconnectedness of product and service supply chains traditionally mapped with tools capturing unreliable self-report data often done by third parties not directly involved in the transaction (e.g., secretaries).

As illustrated in FIG. 2, the communication monitoring system 102 includes a processing device 204 coupled to a communication device 206. The processing device 204 is also coupled to a memory device 208, and an input/output (“I/O”) interface 110. In embodiments, the communication device 206 enables the communication monitoring system 102 to communicate with other devices and systems via the one or more networks 116. The communication monitoring system 102 can communicate with the participant 104, operating a user device 120, via the network 116, and the communication monitoring system 102 can communicate with the participant 106, operating a user device 122, via the network 116.

According to the aspects of the present disclosure, the user device 120 can store and execute a copy of a communication application 220 that allows the user device 122 to communicate via the networks 116. Likewise, the user device 122 can store and execute a copy of a communication application 222 that allows the user device 122 to communicate via the networks 116. In some embodiments, the communication application 220 and/or communication application 222 can be a specifically designed application that operates with the communication monitoring system 102 to perform the processes and methods described herein. In some embodiments, the communication application 220 and/or communication application 222 can be a third-party application, such as a web browser, electronic mail application, etc., that forwards electronic communications to the communication monitoring system 102 to perform the processes and methods described herein.

To perform the process described herein, the communication monitoring system 102 can store and execute an interface module 140, a message analysis application 242, and a storage module 244 to perform the processes and methods described herein. The interface module 240, the message analysis application 242, and the storage module 244 can be stored in the memory device 108. The interface module 240, the message analysis application 242, and the storage module 244 can include the necessary logic, instructions, and/or programming to perform the processes and methods described herein. The interface module 240, the message analysis application 242, and the storage module 244 can be written in any programming language.

The memory device 208 can also include one or more databases 214 that stores information and data associated with the process and methods described herein. The databases 214 can store data as described below. The databases 214 can be any type of database, for example, a hierarchical database, a network database, an object-oriented database, a relational database, a non-relational database, an operational database, and the like.

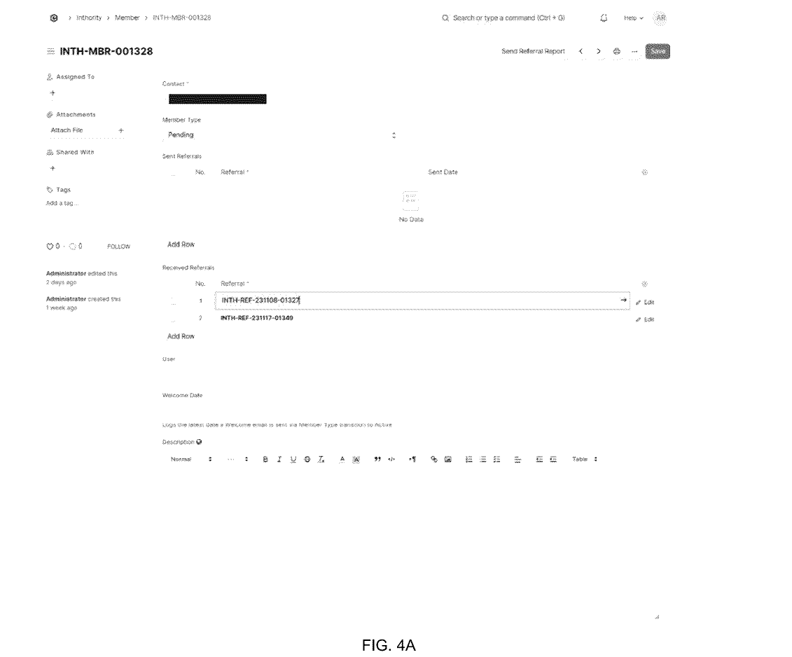

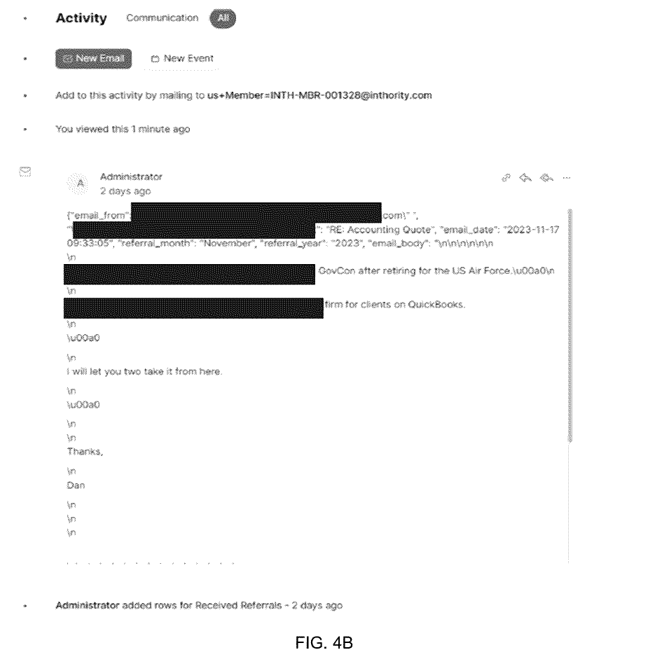

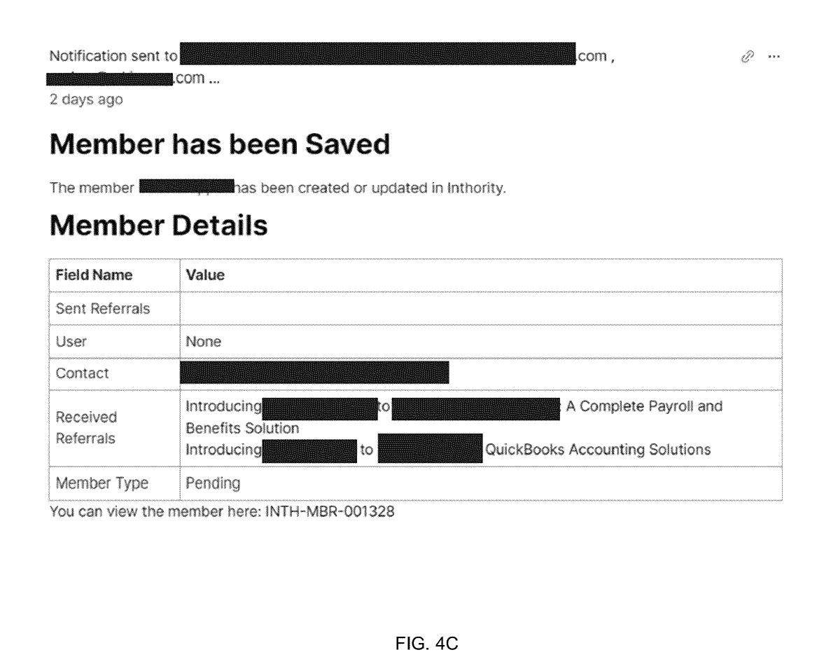

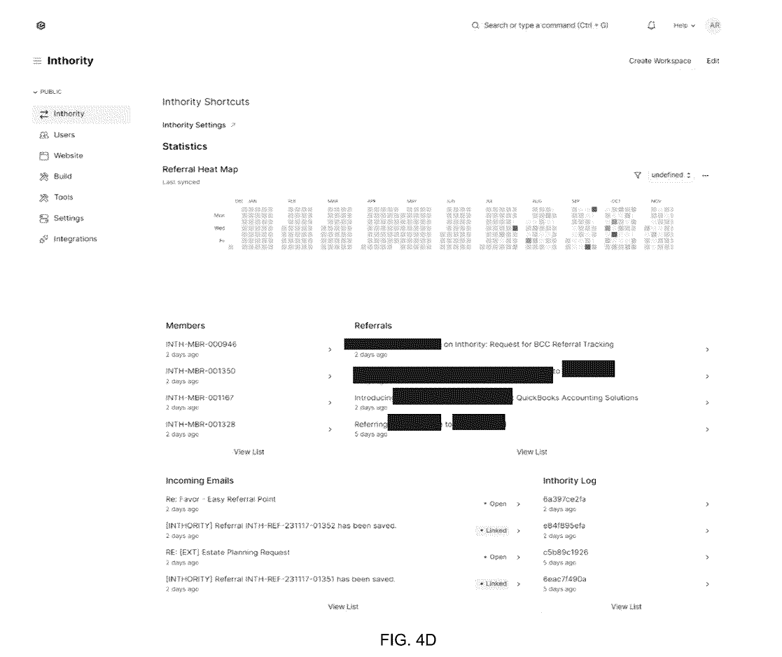

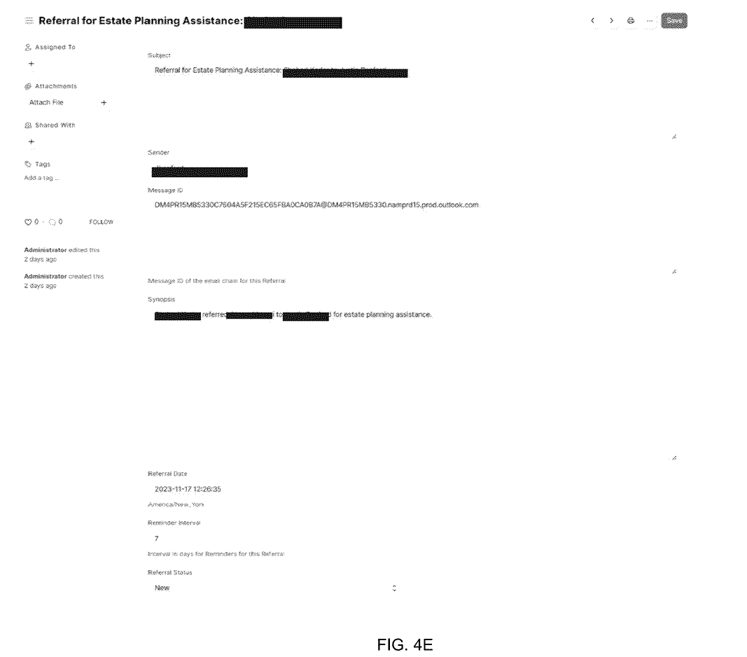

The interface module 240 operates to generate and provide graphical user interfaces (GUIs) to the application 242, for example, menus, widgets, text, images, fields, etc. Additionally, the interface module 240 can provide data to the application 220, and the application 222, which can be used to generate GUls. The GUls generated by the interface module 240 can be interactive. For example, the GUls can allow the participants 120/122 of the user devices 220/222 to access the functionality of the message analysis application 242 as illustrated in FIGS. 4A-4E.

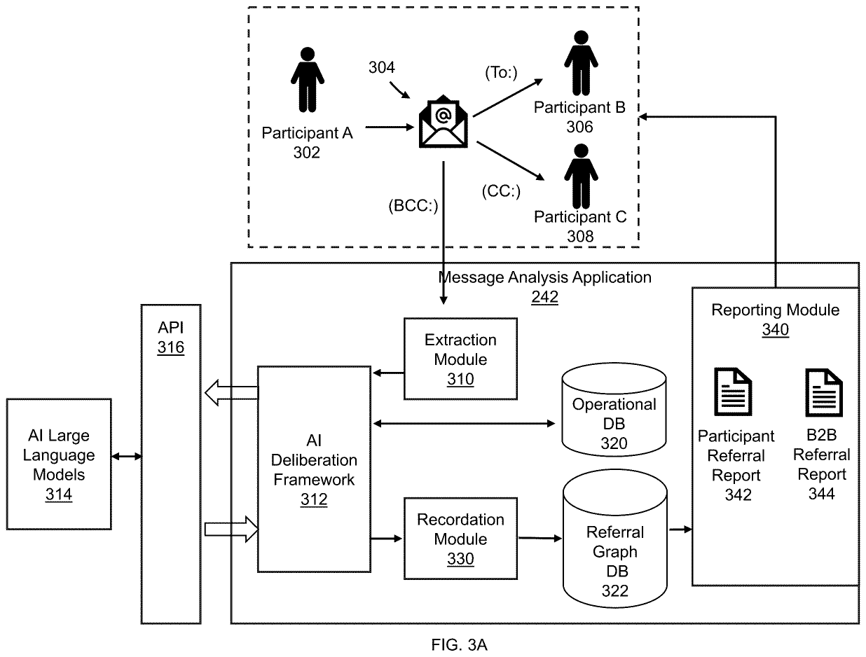

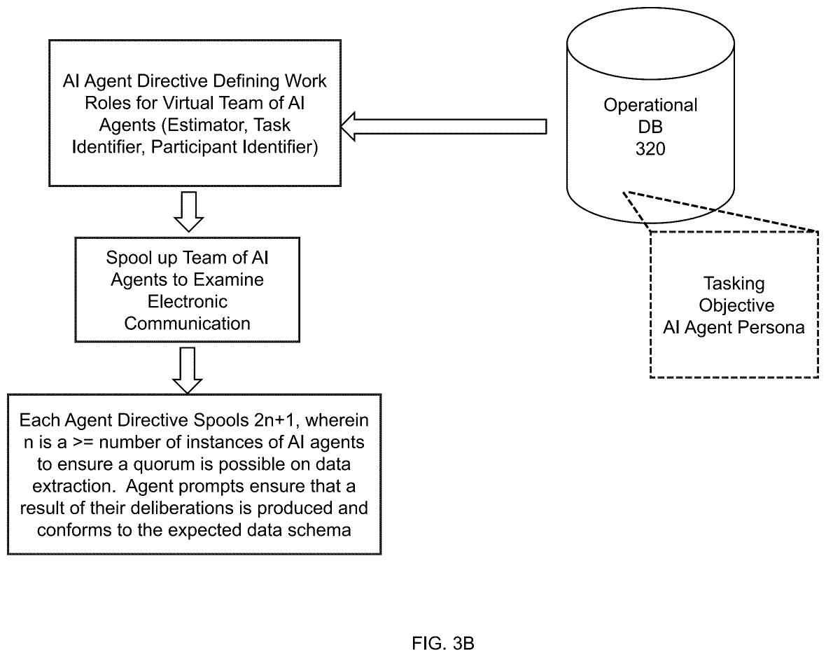

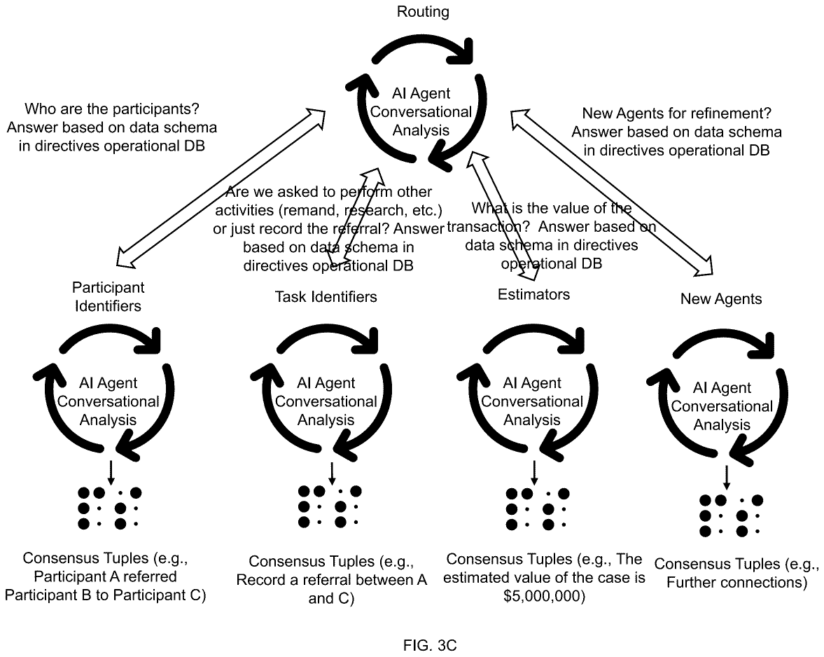

FIGS. 3A-3C illustrates an example of the process flow of the communication monitoring system 102, according to aspects of the present disclosure. While FIGS. 3A-3C illustrate examples of processes and components the communication monitoring system 102 and message analysis application 242, additional components can be added and existing components can be removed and/or modified.

As illustrated in FIGS. 3A-3C, the message analysis application 242 operates to extract data from the electronic communications of the participants in the network environment. For example, a participant A 302 can send an electronic message 304 to a participant B 306 and copy a participant C 308. In order to access the processes of the communications monitoring system, the participant A 302 can blind copy the network address of the communication monitoring system 102, e.g., email address.

In embodiments, the message analysis application 242 can utilize one or more machine learning algorithms and/or models to extract and analyze the data. Once received, the message 304 is processed by an extraction module 310 of the message analysis application 242. In embodiments, the message analysis application 242 is configured to employ electronic message, e.g., email data, parsing and structuring. The message analysis application 242 tracks and parses email threads using unique identifiers, extracts pertinent fields, and analyzes the content to identify the types of activities and the participants. The data is then formatted into structured JavaScript Object Notation (JSON), capturing attributes like sender, recipient, and referral details. After analysis, the data is structured into JSON format and stored in a graph database, enabling complex relationship analysis and efficient data retrieval. In embodiments, the message analysis application 242 can focus on textual data analysis. The message analysis application 242 can be optimized for text-based analysis, sidestepping the handling of non-textual elements within emails. This focused approach ensures high efficiency and accuracy in data interpretation.

In embodiments, once the data from the message 304, the data is processed by an AI deliberation framework 312 that utilizes one or more large language models 314, such as large language models, transformer-based neural networks, recurrent neural networks, convolutional neural networks, or other suitable natural language processing (NLP) technologies capable of interpreting and analyzing textual electronic communication data. via an application programming interface (API) 316. For example, the AI deliberation framework 312 may utilize multiple AI modules—such as large language models, transformer-based neural networks, or other advanced NLP technologies—to simultaneously analyze identical data. These AI modules collaborate through a structured consensus mechanism, allowing multiple interpretations to be deliberated upon, thus resolving ambiguities and enhancing the reliability and accuracy of the final output.

In embodiments, as illustrated in FIGS. 3B and 3C, the AI deliberation framework 312 of the message analysis application 242 utilizes one or more artificial intelligence modules capable of natural language processing. These modules may include, but are not limited to, large language models (LLMs), transformer-based neural networks, recurrent neural networks (RNNs), convolutional neural networks (CNNs), or other suitable AI-based architectures. The AI modules may initially be trained on general datasets, then subsequently fine-tuned on specialized datasets tailored specifically for interpreting electronic communications and referral-related expressions. The AI modules collectively apply advanced natural language processing and machine learning algorithms to accurately analyze, interpret, and extract relational data from electronic messages. The message analysis application 242 employs multiple instances of the AI large language module 314 that process the same email data sets. These instances engage in a dialogue, leveraging their advanced processing abilities to interpret and analyze the content for referral information.

In embodiments, the message analysis application 242 utilizes a consensus mechanism for ambiguity resolution. The message analysis application 242 is configured with a consensus mechanism where multiple instances collaborate to resolve ambiguities. The AI agent conversional analysis enhances the system's accuracy by synthesizing the insights from several AI interpretations and reaching an agreement before finalizing the output. In embodiments, the message analysis application 242 includes algorithms that are been specifically trained on electronic message content, e.g., email content. The message analysis application 242 uses a base large language modle model, pre-trained on extensive data, which is then fine-tuned on a curated dataset focused on email-like structures and referral language. This specialized training enables the AI to understand and extract nuanced referral information more effectively.

In the processes, as illustrated in FIGS. 3B and 3C, the message analysis application 242 uses multiple AI agent instances to analyze and reach a consensus on email content. The specialized training process equips the AI agents to recognize referral patterns within email exchanges. The message analysis application 242 can then store a conversion of complex email threads into a structured, actionable database, for example, an operational database 320. The message analysis application 242 can be trained to extract, process, and manage referral information in a business environment.

For example, the message analysis application 242 can extract current value pairs:

1. “sender”: name of the referral sender, the person making the introduction.

2. “sender_email”: email of the referral sender, matching the sender's name.

3. “recipient”: name of the referral recipient, the person to whom the introduction is made.

4. “recipient_email”: email of the referral recipient, matching the recipient's name.

5. “client”: name of the referral client, the person the sender introduces to the recipient.

6. “client_email”: email of the referral client, matching the client's name.

7. “bystanders”: Any parties included on the To, CC, or BCC lines who do not fit in the above three roles. Return bystanders as a comma-separated list. If a bystander name is not known matching a bystander email, return an empty string in its place. If no bystanders are found, return an empty string.

8. “bystander_emails”: a comma-separated list of emails corresponding to the bystanders list. If any email is not known matching a bystander's name, provide an empty string in its place. If there are no bystander names or emails, return an empty string.

9. “messageType”: message type as one of the following only: “Referral” or “Other”.

10. “synopsis”: a narrative description of the conversation.

In embodiments, the message analysis application 242 utilizes data keys to track and store data in a referral graph database 322. For example, the data keys can be a Message-ID such as this DM4PR15MB53306D2AEFEBC3C14E2C724BA01BA@DM4PR15MB5330.nampr d15.prod.outlook.com. The ID becomes on of our graph keys identifying message relationships. The message analysis application 242 can utilize AI agents to establish participant relationships supported by message properties such as sender, recipient, carbon copied, and blind carbon copied.

In embodiments, the message analysis application 242 can utilize initial conditional logic stage functions as a pre-processing step designed to streamline the efficiency and accuracy of the AI system by determining which emails are suitable for further analysis. The pre-processing stages can include the following components:

1. Email Selection Criteria: The message analysis application 242 first applies rules to select emails that are relevant to the referral extraction process. These criteria might include sender domain verification, keyword presence in the subject line, or certain phrases within the email body that are indicative of a referral.

2. Data Sanitization and Normalization: Incoming emails are sanitized to remove any irrelevant or extraneous content that could hinder the AI's performance. Normalization ensures that different formats or styles of writing do not affect the consistency of the input data to the AI models.

3. Structural Analysis: The message analysis application 242 examines the structure of each email to validate its compatibility with the expected format. Emails that deviate significantly from the standard format (e.g., newsletters, automated replies) might be filtered out at this stage.

4. Priority Tagging: Emails may be tagged based on urgency or relevance scores, which are determined based on predefined logic. For instance, emails containing time-sensitive language could be processed with higher priority.

5. Initial Data Extraction: Before engaging the full capabilities of the AI, the message analysis application 242 performs a lightweight extraction of metadata such as the date, sender, recipient, and subject. This metadata can help in classifying and routing the email through the appropriate AI processing pipeline.

6. Rule-Based Referral Indicators: The message analysis application 242 applies a set of rule-based indicators that suggest the presence of a referral, such as the mention of a person's name along with certain action verbs or the presence of introductory phrases commonly used in referrals.

7. Routing Decisions: Based on the outcomes of the above checks, the message analysis application 242 decides whether to route the email to one or multiple AI instances for deep analysis, to store it for batch processing later, or to flag it for manual review.

The message analysis application 242 can utilize a data structure to store the data parsed from electronic communications. For example, the data structure can take the form:

Notification sent to *** @***.com, *** @***.com, *** @***.com . . . 2 days ago

### Referral Details

| Field Name | Value |
|---|---|
| Subject | Referral for Estate Planning Assistance: John Doe to Jane Doe |
| Synopsis | John Roe referred John Doe to Jane Doe for estate planning assistance. |
| Referral | New |
| Status | |
| Connections | {{ no such element: inthority.inthority.doctype.referral.referral.Referral |
| | object[‘connections_tab’] }} |
| Synopsis | You act as a business analyst, examining threaded email chains for referral |
| Prompt | activity between parties. Analyze the provided email chain and return a |
| | structured, JSON-formatted response using straight quote marks only and no |
| | extra text. For the first eight JSON items, use entity extraction to determine |
| | the names and email addresses of the parties. If any of these cannot be found, |
| | return only an empty string for that field. Do not return “I don't know” or any |
| | other explanatory text. Do not mention any bystander role by that name in the |
| | generated synopsis. If you are unsure about any information, please provide |
| | your best choice with a lower confidence score, but do not make up any |
| | responses. When you have completed the analysis, please double-check your |
| | responses for clarity and accuracy and ensure that all data is factual. Please |
| | format the JSON output with only the following fields: 1. “sender”: name of |
| | the referral sender, the person making the introduction. 2. “sender_email”: |
| | email of the referral sender, matching the sender's name. 3. “recipient”: name |
| | of the referral recipient, the person to whom the introduction is made. 4. |
| | “recipient_email”: email of the referral recipient, matching the recipient's |
| | name. 5. “client”: name of the referral client, the person the sender introduces |
| | to the recipient. 6. “client_email”: email of the referral client, matching the |
| | client's name. 7. “bystanders”: Any parties included on the To, CC, or BCC |
| | lines who do not fit in the above three roles. Return bystanders as a comma- |
| | separated list. If a bystander name is not known matching a bystander email, |
| | return an empty string in its place. If no bystanders are found, return an empty |
| | string. 8. “bystander_emails”: a comma-separated list of emails corresponding |
| | to the bystanders list. If any email is not known matching a bystander's name, |
| | provide an empty string in its place. If there are no bystander names or emails, |
| | return an empty string. 9. “messageType”: message type as one of the |
| | following only: “Referral” or “Other”. 10. “synopsis”: a narrative description |
| | of the conversation. 11. “confidenceScore”: confidence score (between 0 and |
| | 1) for the combined output. |
| AI Details | {{ no such element: inthority.inthority.doctype.referral.referral.Referral |
| | object[‘ai_details_section’] }} |
| Referral | Referral |
| Type | |
| Sender | Jdoe |
| Referral | 2023-11-17 12:26:35 |
| Date | |
| Raw | { “sender”: “John Roe”, “sender_email”: “”, “recipient”: “Jane Doe”, |
| Response | “recipient_email”: “janedoe@****.com”, “client”: “John Doe”, |
| | “client_email”: “johndoe@*****.com”, “bystanders”: “”, |
| | “bystander_emails”: “”, “messageType”: “Referral”, “synopsis”: “John Roe |
| | referred John Doe to Jane Doe for estate planning assistance.”, |
| | “confidenceScore”: 1.0 } |
| Confidence | 1.0 |
| Score | |
| Communications | [<ReferralCommunication: 06db771d20 parent=INTH-REF-231117-01351>] |
| Message ID | DM4PR15MB5330C7604A5F215EC65FBA0CA0B7A@DM4PR15MB533 |
| | 0.namprd15.prod.outlook.com |
| Client | [<ReferralClient: ca62d273ed parent=INTH-REF-231117-01351>] |
| Reminder | 7 |
| Interval | |
| Referral | [<ReferralEvent: b404cbca12 parent=INTH-REF-231117-01351>] |
| Event | |

Once the data has been processed, output of the AI modules can be stored in a referral graph database 322 by a recordation module 330. The data can include relation connection between the participants and other data agreed on by the AI agents as illustrated in FIG. 3C. A reporting module 340 can produce reports, e.g., a participant referral report 342 and a business-to-business referral report 344 using the data stored in the referral graph database 322. FIGS. 4A-4E illustrate examples of reports.

Returning to FIG. 2, the processing device 204, the communication device 206, the memory device 208, and the I/O interface 210 can be interconnected via a system bus. The system bus can be and/or include a control bus, a data bus, an address bus, and the like. The processing device 204 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 2 illustrates a single processing device 204, the communication monitoring system 102 can include multiple processing devices 204, whether the same type or different types.

The memory device 208 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 208. While FIG. 2 illustrates a single memory device 208, the communication monitoring system 102 can include multiple memory devices 208, whether the same type or different types.

The communication device 204 enables the communication monitoring system 102 to communicate with other devices and systems. The communication device 204 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The communication monitoring system 102 can communicate with one or more network resources via the network 116. The one or more network resources can include external databases, social media platforms, search engines, file servers, web servers, or any type of computerized resource that can communicate with the communication monitoring system 102 via the network 116.

In embodiments, the components and functionality of the communication monitoring system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the communication monitoring system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the communication monitoring system 102, the user device 120, and the user device 122 can include a user interface for outputting information in a format perceptible by a user and receiving input from the user. For example, the communication monitoring system 102 can communicate with the user interface via the I/O interface 112. The user interface can display graphical user interfaces (“GUIs”) generated by the communication monitoring system 102 and/or the applications 220/222. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for tracking electronic communications, comprising:
receiving an electronic message between a first user and a second user;
parsing the electronic message to extract data and metadata;
providing the data and the metadata to a plurality of artificial intelligence (AI) agents, wherein each AI agent employs a natural language processing model trained to analyze electronic messages;
enabling the plurality of AI agents to collaboratively determine, through a consensus mechanism, relational connections among the first user, the second user, and additional users based on predefined directives;
storing the relational connections identified by the AI agents in a structured database;
generating a relational report including at least one relational connection identified between the second user and a third user; and
transmitting the relational report to at least one of the first user or the second user.

2. The method of claim 1, wherein the natural language processing model comprises one or more of large language models; transformer-based neural networks; recurrent neural networks; or convolutional neural networks.

3. The method of claim 1, wherein the AI agents utilize a quorum-based consensus mechanism to resolve ambiguities and achieve agreement on the relational connections.

4. The method of claim 1, the method further comprising:
performing an economic valuation of the relational connection identified between the second user and the third user based on criteria defined within the predefined directives.

5. The method of claim 1, the method further comprising:
applying initial conditional logic stages to perform email selection, data sanitization, structural analysis, priority tagging, initial data extraction, and referral indicator checks prior to analysis by the plurality of AI agents.

6. The method of claim 1, the method further comprising:
applying the data and the metadata to a second group of AI agents, wherein the second group of AI agents are configured to the determine, through a consensus mechanism, additional results based on second predefined directives.

7. A computer-readable medium storing instructions for causing a processor to perform a method for tracking electronic communications, the method comprising:
receiving an electronic message between a first user and a second user;
parsing the electronic message to extract data and metadata;
providing the data and the metadata to a plurality of artificial intelligence (AI) agents, wherein each AI agent employs a natural language processing model trained to analyze electronic messages;
enabling the plurality of AI agents to collaboratively determine, through a consensus mechanism, relational connections among the first user, the second user, and additional users based on predefined directives;
storing the relational connections identified by the AI agents in a structured database;
generating a relational report including at least one relational connection identified between the second user and a third user; and
transmitting the relational report to at least one of the first user or the second user.

8. The computer-readable medium of claim 7, wherein the natural language processing model comprises one or more of large language models; transformer-based neural networks; recurrent neural networks; or convolutional neural networks.

9. The computer-readable medium of claim 7, wherein the AI agents utilize a quorum-based consensus mechanism to resolve ambiguities and achieve agreement on the relational connections.

10. The computer-readable medium of claim 7, the method further comprising:
performing an economic valuation of the relational connection identified between the second user and the third user based on criteria defined within the predefined directives.

11. The computer-readable medium of claim 7, the method further comprising:
applying initial conditional logic stages to perform email selection, data sanitization, structural analysis, priority tagging, initial data extraction, and referral indicator checks prior to analysis by the plurality of AI agents.

12. The computer-readable medium of claim 7, the method further comprising:
applying the data and the metadata to a second group of AI agents, wherein the second group of AI agents are configured to the determine, through a consensus mechanism, additional results based on second predefined directives.

13. A method for tracking electronic communications, comprising:
receiving an electronic mail message between a first user and a second user;
parsing the electronic message to extract data and metadata;
providing the data and the metadata to a plurality of artificial intelligence (AI) agents, wherein each AI agent employs a natural language processing model trained to analyze electronic messages;
determining, via the AI agents, relational connections among the first user, the second user, and additional users;
storing the relational connections identified by the AI agents in a structured database;
providing the relational connections to a relationship management application.

14. The method of claim 13, wherein the natural language processing model comprises one or more of large language models; transformer-based neural networks; recurrent neural networks; or convolutional neural networks.

15. The method of claim 14, wherein:
the plurality of AI agents collaboratively determine, through a consensus mechanism, the relational connections based on predefined directives, and
the AI agents utilize a quorum-based consensus mechanism to resolve ambiguities and achieve agreement on the relational connections.

16. The method of claim 13, the method further comprising:
performing an economic valuation of the relational connection identified between the second user and the third user based on criteria defined within the predefined directives.

17. The method of claim 13, the method further comprising:
applying initial conditional logic stages to perform electronic mail message selection, data sanitization, structural analysis, priority tagging, initial data extraction, and referral indicator checks prior to analysis by the plurality of AI agents.

18. The method of claim 13, the method further comprising:
determining that the relational connection is a referral.
